(19) United States
(12) Patent Application Publication
(10) Pub. No.: US 2020/0377722 A1
(43) Pub. Date: Dec. 3, 2020

(54) CLEAR POLYCARBONATE RESINS

(71) Applicant: SABIC GLOBAL TECHNOLOGIES B.V., Bergen op Zoom (NL)

(72) Inventors: Binbin ZHOU, Shanghai (CN); Jong-Min CHOI, Gyonggi-do (KR); Wei ZHAO, Evansville, IN (US)

(21) Appl. No.: 16/630,018

(22) PCT Filed: Jul. 11, 2018
(86) PCT No.: PCT/US2018/041561

§ 371 Date: Jan. 10, 2020

Related U.S. Application Data
(60) Provisional application No. 62/530,931, filed on Jul. 11, 2017.

(51) Int. Cl. C08L 69/00

(52) U.S. Cl. CPC C08L 69/005; C08L 2205/03; C08L 2205/025; C08L 2201/10

(57) ABSTRACT

Compositions and articles include: (a) at least one poly(aliphatic ester)-poly carbonate copolymer; (b) at least one polymer having ester linkages; and (c) a flat glass fiber. Methods of forming an article include: blending at least one poly(aliphatic ester)-poly carbonate copolymer, at least one polymer having ester linkages, and flat glass fiber to form a polymer mixture; and molding the polymer mixture to form the article.

### TECHNICAL FIELD

The disclosure concerns clear glass filled polycarbonate compositions having excellent light transmission rate, low level of haze, low warpage of molded part, while still maintaining key mechanical properties with good melt flowability.

### BACKGROUND

Glass fiber filled thermoplastic materials are widely used in the consumer electronic market, but for these materials to replace glass, the materials need to achieve high clarity and transparency, crystal clear color, low birefringence, low warpage and good mechanical performance. Optical performance of state of the art products is not good enough to provide glass-like performance. Use of such products typically shows warpage when molded into parts for screens of mobile phones, computer tablets, computer monitors and televisions.

These and other shortcomings are addressed by aspects of the disclosure.

### SUMMARY

The disclosure concerns articles comprising: (a) at least one poly(aliphatic ester)-polycarbonate copolymer; (b) at least one polymer having ester linkages; and (c) flat glass fiber.

The disclosure also relates to compositions comprising: (a) at least one poly(aliphatic ester)-polycarbonate copolymer; (b) at least one polymer having ester linkages; and (c) flat glass fiber.

In certain aspects, the disclosure relates to method of forming an article comprising:
blending at least one poly(aliphatic ester)-polycarbonate copolymer, at least one polymer having ester linkages, and flat glass fiber to form a polymer mixture; and
molding the polymer mixture to form the article.

### BRIEF DESCRIPTION OF THE DRAWINGS

FIG. 1 presents a comparison of transparency and haze levels using the instant process.

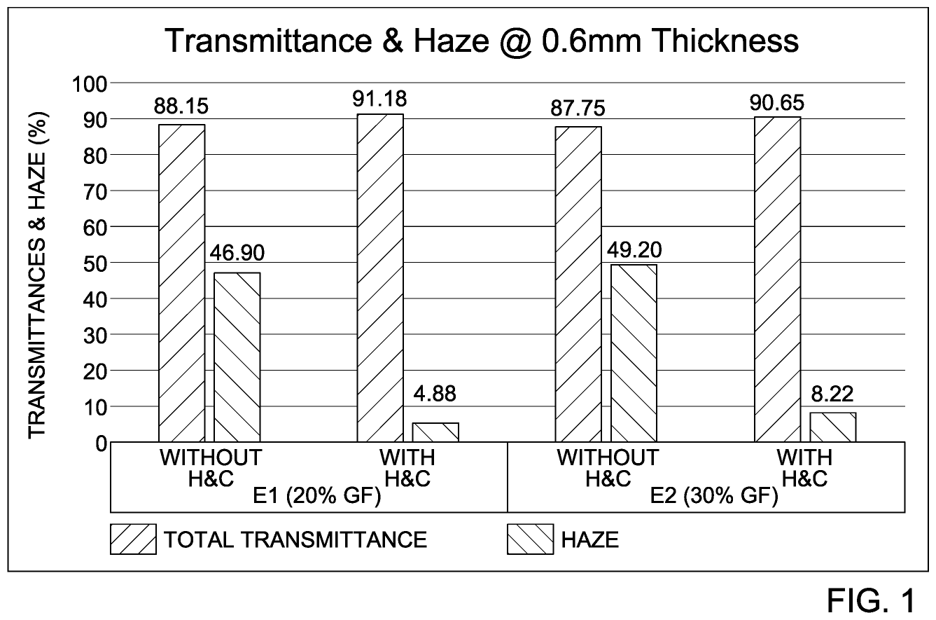

FIG. 2 presents transmittance and haze comparisons with and without the instant process.

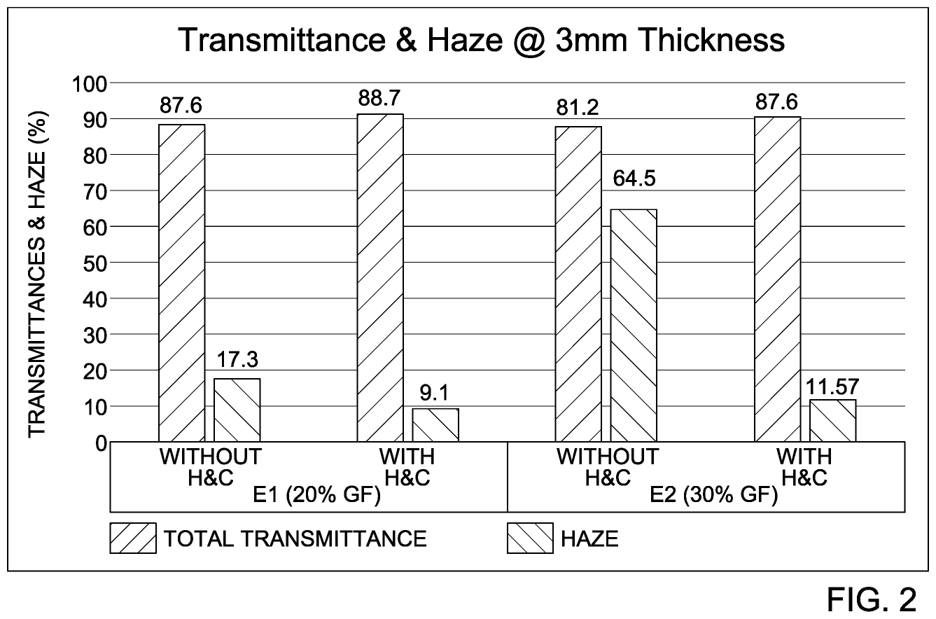

### DETAILED DESCRIPTION OF ILLUSTRATIVE ASPECTS

The disclosure generally concerns clear glass filled polycarbonate compositions having excellent light transmission rate, low level of haze, low warpage of molded part, while still maintaining certain mechanical properties with good melt flowability.

All publications mentioned herein are incorporated herein by reference to, for example, disclose and describe the methods and/or materials in connection with which the publications are cited.

### Definitions

It is also to be understood that the terminology used herein is for the purpose of describing particular aspects only and is not intended to be limiting. As used in the specification and in the claims, the term “comprising” can include the aspects “consisting of” and “consisting essentially of” Unless defined otherwise, all technical and scientific terms used herein have the same meaning as commonly understood by one of ordinary skill in the art to which this disclosure belongs.

As used in the specification and the appended claims, the singular forms “a,” “an” and “the” include plural referents unless the context clearly dictates otherwise. Thus, for example, reference to “a polyamide polymer” includes mixtures of two or more polyamide polymers.

As used herein, the term “co b ation” is inclusive of blends, mixtures, reaction products, and the like.

Ranges can be expressed herein as from one value (first value) to another value (second value). When such a range is expressed, the range includes in some aspects one or both of the first value and the second value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the designated value, approximately the designated value, or about the same as the designated value. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally substituted alkyl” means that the alkyl group can or cannot be substituted and that the description includes both substituted and unsubstituted alkyl groups.

As used herein, the term “effective amount” refers to an amount that is sufficient to achieve the desired modification of a physical property of the composition or material. For example, an “effective amount” of a thermally conductive filler refers to an amount that is sufficient to achieve the desired improvement in the property modulated by the formulation component, e.g. achieving the desired level of thermal conductivity. The specific level in terms of wt % in a composition required as an effective amount will depend upon a variety of factors including the amount and type of polyamide, amount and type of laser direct structure additive, amount and type of thermally conductive filler, and end use of the article made using the composition.

Disclosed are the components to be used to prepare the compositions of the disclosure as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the disclosure. Thus, if there are a variety of additional steps that can be performed it is understood that each of these additional steps can be performed with any specific aspect or combination of aspects of the methods of the disclosure.

References in the specification and concluding claims to parts by weight of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

As used herein the terms “weight percent,” “wt %,” and “wt. %,” which can be used interchangeably, indicate the percent by weight of a given component based on the total weight of the composition, unless otherwise specified. That is, unless otherwise specified, all wt % values are based on the total weight of the composition. It should be understood that the sum of wt % values for all components in a disclosed composition or formulation are equal to 100.

Unless otherwise specified, molecular weights discussed herein are weight average molecular weights. As used herein, the terms “weight average molecular weight” or “Mw” can be used interchangeably, and are defined by the formula:

$${M}_{w} = \frac{Σ {N}_{i} {M}_{i}^{2}}{Σ {N}_{i} {M}_{i}} ,$$

where Mᵢ is the molecular weight of a chain and Nᵢ is the number of chains of that molecular weight. Compared to Mₙ, M_{w} takes into account the molecular weight of a given chain in determining contributions to the molecular weight average. Thus, the greater the molecular weight of a given chain, the more the chain contributes to the M_{w}. M_{w} can be determined for polymers, e.g. polycarbonate polymers, by methods well known to a person having ordinary skill in the art using molecular weight standards, e.g. polycarbonate standards or polystyrene standards, such as certified or traceable molecular weight standards.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### Polycarbonate Polymer

The terms “polycarbonate” or “polycarbonates” as used herein include copolycarbonates, homopolycarbonates, (co)polyester carbonates and combinations thereof

The term polycarbonate can be further defined as compositions have repeating structural units of the formula (1):

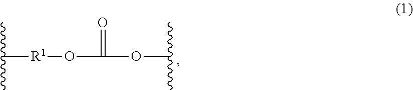

in which at least 60 percent of the total number of R¹ groups are aromatic organic radicals and the balance thereof are aliphatic, alicyclic, or aromatic radicals. In a further aspect, each R¹ is an aromatic organic radical and, in particular, a radical of the formula (2):

—A¹—Y¹—A²— (2)

wherein each of A¹ and A² is a monocyclic divalent aryl radical and Y¹ is a bridging radical having one or two atoms that separate A¹ from A². In various aspects, one atom separates A¹ from A². For example, radicals of this type include, but are not limited to, radicals such as —O—, —S—, —S(O)—, —S(O₂)—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y¹ may be a hydrocarbon group or a saturated hydrocarbon group such as methylene, cyclohexylidene, or isopropylidene. Polycarbonate materials include materials disclosed and described in U.S. Pat. No. 7,786,246, which is hereby incorporated by reference in its entirety for the specific purpose of disclosing various polycarbonate compositions and methods for manufacture of same. Polycarbonate polymers can be manufactured by means known to those skilled in the art.

Some polycarbonates are linear bisphenol-A polycarbonates produced by melt polymerization. The melt polycarbonate process is based on continuous reaction of a dihydroxy compound and a carbonate source in a molten stage. The reaction can occur in a series of reactors where the combined effect of catalyst, temperature, vacuum, and agitation allows for monomer reaction and removal of reaction by-products to displace the reaction equilibrium and effect polymer chain growth. A common polycarbonate made in melt polymerization reactions is derived from bisphenol A (BPA) via reaction with diphenyl carbonate (DPC). This reaction can be catalyzed by, for example, tetra methyl ammonium hydroxide (TMAOH) or tetrabutyl phosphonium acetate (TBPA), which can be added in to a monomer mixture prior to being introduced to a first polymerization unit and sodium hydroxide (NaOH), which can be added to the first reactor or upstream of the first reactor and after a monomer mixer.

The polycarbonates may be linear bisphenol-A polycarbonates produced by melt polymerization. The melt polycarbonate process is based on continuous reaction of a dihydroxy compound and a carbonate source in a molten stage. The reaction can occur in a series of reactors where the combined effect of catalyst, temperature, vacuum, and agitation allows for monomer reaction and removal of reaction by-products to displace the reaction equilibrium and effect polymer chain growth. A common polycarbonate made in melt polymerization reactions is derived from bisphenol A (BPA) via reaction with diphenyl carbonate (DPC). This reaction can be catalyzed by, for example, tetra methyl ammonium hydroxide (TMAOH) or tetrabutyl phosphonium acetate (TBPA), which can be added in to a monomer mixture prior to being introduced to a first polymerization unit and sodium hydroxide (NaOH), which can be added to the first reactor or upstream of the first reactor and after a monomer mixer.

The melt polycarbonate in some aspects may have a molecular weight (Mw) of about 15,000 to about 120,000 Dalton on a polystyrene basis The melt polycarbonate product may have an endcap level of about 45% to about 80%. Some polycarbonates have an endcap level of about 45% to about 75%, about 55% to about 75%, about 60% to about 70% or about 60% to about 65%. Certain polycarbonates have at least 200 ppm of hydroxide groups. Certain polycarbonates have 200-1100 ppm or 950 to 1050 ppm hydroxide groups.

The polycarbonate polymer may contain endcapping agents. Any suitable endcapping agents can be used provided that such agents do not significantly adversely impact the desired properties of the polycarbonate composition (transparency, for example). Endcapping agents include mono-phenolic compounds, mono-carboxylic acid chlorides, and/or mono-chloroformates. Mono-phenolic endcapping agents are exemplified by monocyclic phenols such as phenol and C₁-C₂₂ alkyl-substituted phenols such as p-cumyl-phenol, resorcinol monobenzoate, and p- and tertiary-butyl phenol; and monoethers of diphenols, such as p-methoxyphenol.

In some compositions, the polycarbonate polymer comprises at least one polycarbonate polymer having a molecular weight (Mw) of at least 20,000 g/mol and a second polycarbonate polymer have a molecular weight (Mw) of less than 20,000 g/mol. In some compositions, the molar ratio of said first polycarbonate polymer to said second polycarbonate polymer is about 1.4:1 to about 3.2:1. In other compositions, the molar ratio of said first polycarbonate polymer to said second polycarbonate polymer is about 1.5:1 to about 3.0:1.

The polycarbonate compositions of the present disclosure contain at least one poly(aliphatic ester)-polycarbonate copolymer (A). The poly(aliphatic ester)-polycarbonate copolymer is made up of a combination of carbonate units and aliphatic ester units.

In aspects, the ester unit may have the structure of following formula.

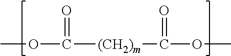

wherein m is from about 4 to about 18. In some aspects, m is from about 8 to about 10. The ester units may be derived from a C6-C20 aliphatic dicarboxylic acid (which includes the terminal carboxylate groups) or a reactive derivative thereof, including a C8-C12 aliphatic dicarboxylic acid. In some aspects, the terminal carboxylate groups are derived from the corresponding dicarboxylic acid or reactive derivative thereof, such as the acid halide (specifically, the acid chloride), an ester, or the like. Exemplary dicarboxylic acids (from which the corresponding acid chlorides may be derived) include C6 dicarboxylic acids such as hexanedioic acid (also referred to as adipic acid); C10 dicarboxylic acids such as decanedioic acid (also referred to as sebacic acid); and alpha, omega C12 dicarboxylic acids such as dodecanedioic acid (sometimes abbreviated as DDDA). It will be appreciated that the aliphatic dicarboxylic acid is not limited to these exemplary carbon chain lengths, and that other chain lengths within the C6-C20 range may be used.

A specific aspect of a poly(aliphatic ester)-polycarbonate copolymer/dipolymer having ester units comprising a straight chain methylene group and a polycarbonate group is shown in formula:

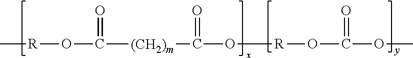

where m is 4 to 18; x and y represent average molar percentages of the aliphatic ester units and the carbonate units in the copolymer. The average molar percentage ratio x:y may be from 99:1 to 1:99, including from about 13:87 to about 2:98, or from about 9:91 to about 2:98 or from about 8:92 to 13:87. Each R may be independently derived from a dihydroxy compound, such as bisphenol-A. In a specific exemplary aspect, a useful poly(aliphatic ester)-polycarbonate copolymer/dipolymer comprises sebacic acid ester units and bisphenol A carbonate units (Formula (II), where m is 8, and the average molar ratio of x:y is 6:94). Such poly(aliphatic ester)-polycarbonate copolymers are commercially available as LEXAN HFD copolymers (LEXAN is a trademark of SABIC Innovative Plastics IP B. V.).

In some aspects, the poly(aliphatic ester)polycarbonate copolymer may have a weight average molecular weight of from about 15,000 to about 40,000, including from about 20,000 to about 38,000 (measured by GPC based on BPA polycarbonate standards). The polycarbonate compositions of the present disclosure may include from about 30 wt % to about 85 wt % of the poly(aliphatic ester)-polycarbonate copolymer.

In some aspects of the present disclosure, the polycarbonate composition includes at least two poly(aliphatic ester)-polycarbonate copolymers, e.g., a first poly(aliphatic ester)-polycarbonate copolymer (Al) and a second poly(aliphatic ester)-polycarbonate copolymer (A2). The poly(aliphatic ester)-polycarbonate copolymers may have the same or different ester unit and the same or different carbonate unit.

In certain aspects the second poly(aliphatic ester)-polycarbonate copolymer has a greater weight average molecular weight than the first poly(aliphatic ester)-polycarbonate copolymer. The first poly(aliphatic ester)-polycarbonate copolymer may have a weight average molecular weight of from about 15,000 to about 25,000, including from about 20,000 to about 22,000 (measured by GPC based on BPA polycarbonate standards). Referring to Formula (III), the first poly(aliphatic ester)-polycarbonate copolymer may have an average molar percentage ratio x:y of from about 4:96 to about 7:93. The second poly(aliphatic ester)-polycarbonate copolymer may have a weight average molecular weight of 30,000 to about 40,000, including from about 35,000 to about 38,000 (measured by GPC based on BPA polycarbonate standards). Referring to Formula (III), the second poly(aliphatic ester)-polycarbonate copolymer may have an average molar percentage ratio x:y of from about 7:93 to about 13:87. In aspects, the weight ratio of the first poly(aliphatic ester)-polycarbonate copolymer to the second poly(aliphatic ester)-polycarbonate copolymer may be at least 1:1, and in further aspects is at least 2:1, at least 3:1, or at least 4:1. In some aspects, the weight ratio is from about 3:2 to about 20:1 (i.e. from about 1.5 to about 20). Note the weight ratio described here is the ratio of the amounts of the two copolymers in the composition, not the ratio of the molecular weights of the two copolymers. The weight ratio between the two poly(aliphatic ester)-polycarbonate copolymers will affect the flow properties, ductility, and surface aesthetics of the final composition. The composition may contain from about 60 to about 99 wt % of the first poly(aliphatic ester)-polycarbonate copolymer. The composition may contain from about 1 to about 40 wt % of the second poly(aliphatic ester)-polycarbonate copolymer. In specific aspects, the composition contains from about 70 to about 99 wt % of the first poly(aliphatic ester)-polycarbonate copolymer and from about 3 to about 30 wt % of the second poly(aliphatic ester)-polycarbonate copolymer.

In particular aspects, the poly(aliphatic ester)-polycarbonate copolymer may have from 4.0 mole % to 12.0 mole % of sebacic acid (of the copolymer). In more specific aspects, the poly(aliphatic ester)-polycarbonate copolymer may have about 6.0 mole % or about 8.25 mole % of sebacic acid.

In particular aspects, the poly(aliphatic ester)-polycarbonate copolymer may have a biocontent of from about 4 wt % to about 10 wt %. The biocontent can be measured according to ASTM D6866.

The poly(aliphatic ester)-polycarbonate copolymer (A) can be manufactured by processes known in the art, such as interfacial polymerization and melt polymerization. Although the reaction conditions for interfacial polymerization may vary, an exemplary process generally involves dissolving or dispersing a dihydric phenol reactant in aqueous caustic soda or potash, adding the resulting mixture to a suitable water-immiscible solvent medium, and contacting the reactants with a carbonate precursor in the presence of a suitable catalyst such as triethylamine or a phase transfer catalyst, under controlled pH conditions, e.g., about 8 to about 10. Generally, in the melt polymerization process, polycarbonates may be prepared by co-reacting, in a molten state, the dihydroxy reactant(s) and a diaryl carbonate ester, such as diphenyl carbonate, in the presence of a transesterification catalyst in a Banbury™ mixer, twin screw extruder, or the like to form a uniform dispersion. Volatile monohydric phenol is removed from the molten reactants by distillation and the polymer is isolated as a molten residue.

Generally, the poly(aliphatic ester)-polycarbonate copolymer (A) can be made as follows. Bisphenol-A and sebacic acid are weighed, then transferred to a formulation tank which contains methylene chloride, water, triethyamine (catalyst) and a small amount of aqueous sodium hydroxide. The mixture is agitated for 5 minutes and then transferred to the polymerization reactor. Phosgene is added to the reaction mixture over the course of 25 minutes. P-cumylphenol is added to the polymerization reactor over the course of five minutes during the phosgenation. Aqueous sodium hydroxide is additionally added in order to control reaction pH.

Alternatively, sebacic acid is dissolved in a mixture of water and aqueous sodium hydroxide. Bisphenol-A is weighed, then transferred to a formulation tank which contains methylene chloride, water and triethylamine (catalyst). The formulation mixture is transferred to the polymerization reactor. The sebacic acid solution is transferred to the polymerization reactor. Phosgene is added to the reaction mixture over the course of 25 minutes. P-cumylphenol is added to the reactor over the course of five minutes during the phosgenation. Aqueous sodium hydroxide is additionally added in order to control reaction pH.

After completion of the polymerization, the reaction mixture is discharged to the centrifuge feed tank. The polymer solution is purified by feeding the reaction product to a train of liquid/liquid centrifuges. The first centrifuge stage separates the reaction by product brine from the resin solution. The second centrifuge stage removes catalyst from the resin solution by washing with dilute aqueous hydrochloric acid. The third centrifuge stage removes residual ionic species by washing the resin solution with water.

The purified resin solution is then concentrated by evaporation of methylene chloride. The resin is then precipitated by co-feeding the resin solution to a jet with steam to flash off the methylene chloride. Residual methylene chloride is removed from the resin by counter current contact with steam. Excess water is removed from the resin using heated air in a fluidizing dryer.

### Polyester Component

As used herein, a “polyester component” is a polymer that has ester linkages, i.e., polyesters. The polymer can be a polyester, which contains only ester linkages between monomers. The polymer can also be a copolyester, which is a copolymer containing ester linkages and potentially other linkages as well.

The polymer having ester linkages can be a polyalkylene terephthalate, for example, poly(butylene terephthalate), also known as PBT, which has the structure shown below:

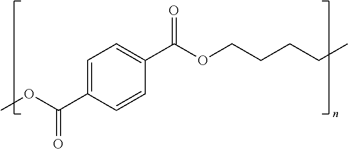

where n is the degree of polymerization, and can be as high as 1,000, and the polymer may have a weight average molecular weight of up to 100,000.

The polymer having ester linkages can be poly(ethylene terephthalate), also known as PET, which has the structure shown below:

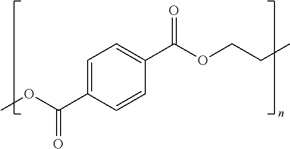

where n is the degree of polymerization, and can be as high as 1,000, and the polymer may have a weight average molecular weight of up to 100,000.

The polymer having ester linkages can be PCTG, which refers to poly(cyclohexylenedimethylene terephthalate), glycol-modified. This is a copolymer formed from 1,4-cyclohexanedimethanol (CHDM), ethylene glycol, and terephthalic acid. The two diols react with the diacid to form a copolyester. The resulting copolyester has the structure shown below:

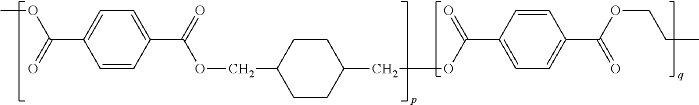

where p is the molar percentage of repeating units derived from CHDM, q is the molar percentage of repeating units derived from ethylene glycol, and p>q, and the polymer may have a weight average molecular weight of up to 100,000.

The polymer having ester linkages can also be PETG. PETG has the same structure as PCTG, except that the ethylene glycol is 50 mol % or more of the diol content. PETG is an abbreviation for polyethylene terephthalate, glycol-modified.

The polymer having ester linkages can be poly(1,4-cyclohexane-dimethanol-1,4-cyclohexanedicarboxylate), i.e. PCCD, which is a polyester formed from the reaction of CHDM with dimethyl cyclohexane-1,4-dicarboxylate. PCCD has the structure shown below:

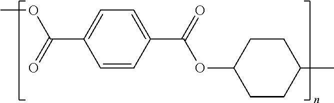

where n is the degree of polymerization, and can be as high as 1,000, and the polymer may have a weight average molecular weight of up to 100,000.

The polymer having ester linkages can be poly(ethylene naphthalate), also known as PEN, which has the structure shown below:

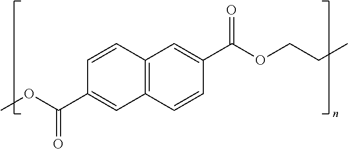

where n is the degree of polymerization, and can be as high as 1,000, and the polymer may have a weight average molecular weight of up to 100,000.

The polymer having ester linkages can also be a copolyestercarbonate. A copolyestercarbonate contains two sets of repeating units, one having carbonate linkages and the other having ester linkages. This is illustrated in the structure below:

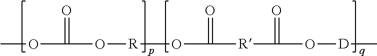

where p is the molar percentage of repeating units having carbonate linkages, q is the molar percentage of repeating units having ester linkages, and p+q=100%; and R, R′, and D are independently divalent radicals.

The divalent radicals R, R′ and D can be made from any combination of aliphatic or aromatic radicals, and can also contain other heteroatoms, such as for example oxygen, sulfur, or halogen. R and D are generally derived from dihydroxy compounds, such as the bisphenols of Formula (A). In particular aspects, R is derived from bisphenol-A. R′ is generally derived from a dicarboxylic acid. Exemplary dicarboxylic acids include isophthalic acid; terephthalic acid; 1,2-di(p-carboxyphenyl)ethane; 4,4′-dicarboxydiphenyl ether; 4,4′-bisbenzoic acid; 1,4-, 1,5-, or 2,6-naphthalenedicarboxylic acids; and cyclohexane dicarboxylic acid. As additional examples, the repeating unit having ester linkages could be butylene terephthalate, ethylene terephthalate, PCCD, or ethylene naphthalate as depicted above.

Aliphatic polyesters can also be used in the disclosure. Examples of aliphatic polyesters include polyesters having repeating units of the following formula:

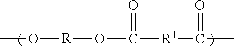

where at least one R or R¹ is an alkyl-containing radical. They are prepared from the polycondensation of glycol and aliphatic dicarboxylic acids.

### Glass Fibers

The glass fibers may be flat or round fibers. So-called flat glass fibers have an elliptical cross-sectional area, and are available from, for example, Nittobo. So-called round fibers have a circular cross-sectional area, where the cross-sectional areas are measured perpendicular to the longitudinal axis of the fiber. The term “substantially circular cross-section” refers to a fiber having a nominally circular cross-section, but where the circularity varies by manufacturing tolerances. The glass fibers may be manufactured from “E-glass,” “A-glass,” “C-glass,” “D- glass,” “R-glass,” “S-glass,” as well as E-glass derivatives that are fluorine-free and/or boron- free. The glass fibers may be woven or non-woven. The glass fibers can have a diameter of about 3 micrometers to about 25 micrometers, specifically about 4 micrometers to about 20 micrometers, and more specifically about 8 micrometers to about 15 micrometers. In some aspects, the glass fibers may comprise one or more “sizing” agents or surface modifiers, which allow the glass fibers to better anchor in the polymer resin, thus allowing for transfer of shear loads from the glass fibers to the thermoset plastic. Such sizing agents or surface modifiers are known to comprise epoxy-based compounds, isocyanate-base compounds, silane-base compounds, and titanate-base compounds, and any one of more may be independently employed here. In other aspects, the glass fibers are free of such sizing agents and/or surface modifiers.

The length of the glass fibers may be selected based on a desired balance of the mechanical characteristics and deformation of the molded article. Exemplary lengths include those in a range from about 25 to 50 microns, from 50 to 100 microns, from 100 to 250 microns, from 250 to 500 microns, from 500 to 1000 microns, from 1000 to 1500 microns, from 1500 to 2000 microns, or any combination of two or more of these ranges.

It has been shown by others that the use of flat glass fibers may be desirable in polyamide systems, to the extent that circular cross-sectioned fibers do not provide sufficient flame retardancy or structural integrity, even for traditional 6,T polyamides. See, for example, U.S. Pat. No. 8,053,500 to Mitsubishi, which shows the inadequacy of glass fibers having a circular cross-section even in hexadiamine-containing polyamides. This Mitsubishi patent describes the need to include 20 to 65% by weight of glass fibers having a non-circular cross-section (flat glass) to achieve adequate performance. As discussed above, the use of 9,T polyamides, for all of its other benefits, only exacerbates the issues of flame retardancy. However, and contrary to this previous teaching, after extensive investigations, we have discovered that the presence of small-diameter glass fibers can be used to provide flame retardant systems without compromising the mechanical strength of the composite. That is, by substituting small diameter circular cross-sectioned glass fibers for all or some of the flat glass fibers, good performance can be realized.

### Additional Components

The additive composition can include an impact modifier, flow modifier, antioxidant, heat stabilizer, light stabilizer, ultraviolet (UV) light stabilizer, UV absorbing additive, plasticizer, lubricant, antistatic agent, anti-fog agent, antimicrobial agent, colorant (e.g., a dye or pigment), surface effect additive, radiation stabilizer, anti-drip agent (e.g., a PTFE-encapsulated styrene-acrylonitrile copolymer (TSAN)), or a combination comprising one or more of the foregoing. For example, a combination of a heat stabilizer and ultraviolet light stabilizer can be used. In general, the additives are used in the amounts generally known to be effective. For example, the total amount of the additive composition can be from about 0.001 to about 10.0 wt %, or from about 0.01 to about 5 wt %, each based on the total weight of all ingredients in the composition.

The composition can include various additives ordinarily incorporated into polymer compositions of this type, with the proviso that the additive(s) are selected so as to not significantly adversely affect the desired properties of the thermoplastic composition (good compatibility for example). Such additives can be mixed at a suitable time during the mixing of the components for forming the composition.

Examples of impact modifiers include natural rubber, fluoroelastomers, ethylene-propylene rubber (EPR), ethylene-butene rubber, ethylene-propylene-diene monomer rubber (EPDM), acrylate rubbers, hydrogenated nitrile rubber (HNBR), silicone elastomers, styrene-butadiene-styrene (SBS), styrene-butadiene rubber (SBR), styrene-(ethylene-butene)-styrene (SEBS), acrylonitrile-butadiene-styrene (ABS), acrylonitrile-ethylene-propylene-diene-styrene (AES), styrene-isoprene-styrene (SIS), styrene-(ethylene-propylene)-styrene (SEPS), methyl methacrylate-butadiene-styrene (MBS), high rubber graft (HRG), and the like. Some suitable impact modifies include PC(polycarbonate)/ABS (such as Cycoloy PC/ABS) and MBS type formulations.

Heat stabilizer additives include organophosphites (e.g. triphenyl phosphite, tris-(2,6-dimethylphenyl)phosphite, tris-(mixed mono-and di-nonylphenyl)phosphite or the like), phosphonates (e.g., dimethylbenzene phosphonate or the like), phosphates (e.g., trimethyl phosphate, or the like), or combinations comprising at least one of the foregoing heat stabilizers. The heat stabilizer can be tris(2,4-di-t-butylphenyl) phosphate available as IRGAPHOS™ 168. Heat stabilizers are generally used in amounts of from about 0.01 to about 5 wt %, based on the total weight of polymer in the composition.

There is considerable overlap among plasticizers, lubricants, and mold release agents, which include, for example, glycerol tristearate (GTS), phthalic acid esters (e.g., octyl-4,5-epoxy-hexahydrophthalate), tris-(octoxycarbonylethyl)isocyanurate, tristearin, di- or polyfunctional aromatic phosphates (e.g., resorcinol tetraphenyl diphosphate (RDP), the bis(diphenyl) phosphate of hydroquinone and the bis(diphenyl) phosphate of bisphenol A); poly-alpha-olefins; epoxidized soybean oil; silicones, including silicone oils (e.g., poly(dimethyl diphenyl siloxanes); esters, for example, fatty acid esters (e.g., alkyl stearyl esters, such as, methyl stearate, stearyl stearate, and the like), polyethylene, waxes (e.g., beeswax, montan wax, paraffin wax, or the like), or combinations comprising at least one of the foregoing plasticizers, lubricants, and mold release agents. These are generally used in amounts of from about 0.01 to about 5 wt %, based on the total weight of the polymer in the composition.

Light stabilizers, in particular ultraviolet light (UV) absorbing additives, also referred to as UV stabilizers, include hydroxybenzophenones (e.g., 2-hydroxy-4-n-octoxy benzophenone), hydroxybenzotriazines, cyanoacrylates, oxanilides, benzoxazinones (e.g., 2,2′-(1,4-phenylene)bis(4H-3,1-benzoxazin-4-one, commercially available under the trade name CYASORB UV-3638 from Cytec), aryl salicylates, hydroxybenzotriazoles (e.g., 2-(2-hydroxy-5-methylphenyl)benzotriazole, 2-(2-hydroxy-5-tert-octylphenyObenzotriazole, and 2-(2H-benzotriazol-2-yl)-4-(1,1,3,3-tetramethylbutyl)-phenol, commercially available under the trade name CYASORB 5411 from Cytec) or combinations comprising at least one of the foregoing light stabilizers. The UV stabilizers can be present in an amount of from about 0.01 to about 1 wt %, specifically, from about 0.1 to about 0.5 wt %, and more specifically, from about 0.15 to about 0.4 wt %, based upon the total weight of polymer in the composition.

Antioxidant additives include organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite; alkylated monophenols or polyphenols; alkylated reaction products of polyphenols with dienes, such as tetrakis[methylene(3,5-di-tert-butyl-4-hydroxyhydrocinnamate)] methane; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate; amides of beta-(3,5-di-tert-butyl-4-hydroxyphenyl)-propionic acid, or combinations comprising at least one of the foregoing antioxidants. Antioxidants are used in amounts of from about 0.01 to about 0.1 parts by weight, based on 100 parts by weight of the total composition, excluding any filler.

Anti-drip agents can also be used in the composition, for example a fibril forming or non-fibril forming fluoropolymer such as polytetrafluoroethylene (PTFE). The anti-drip agent can be encapsulated by a rigid copolymer, for example styrene-acrylonitrile copolymer (SAN). PTFE encapsulated in SAN is known as TSAN. A TSAN comprises about 50 wt % PTFE and about 50 wt % SAN, based on the total weight of the encapsulated fluoropolymer. The SAN can comprise, for example, about 75 wt % styrene and about 25 wt % acrylonitrile based on the total weight of the copolymer. Antidrip agents can be used in amounts of about 0.1 to about 10 parts by weight, based on 100 parts by weight of the total composition, excluding any filler.

### Polymer Mixtures

The polymer compositions can be formed by techniques known to those skilled in the art. Extrusion and mixing techniques, for example, may be utilized to combine the components of the polymer composition.

### Articles of Manufacture

Shaped, formed, or molded articles including the polymer compositions are also provided. The polymer compositions can be molded into useful shaped articles by a variety of means such as injection molding, extrusion, rotational molding, blow molding and thermoforming to form articles such as, for example, parts for screens of mobile phones, computer tablets, computer monitors and televisions.

### Aspects

The present disclosure comprises at least the following aspects.

Aspect 1. An article comprising:
at least one poly(aliphatic ester)-polycarbonate copolymer;
at least one polymer having ester linkages; and
flat glass fiber.

Aspect 2. The article of Aspect 1 comprising:
about 40 to about 70 wt % of at least one poly(aliphatic ester)-polycarbonate copolymer;
about 20 to about 25 wt % of a polymer having ester linkages; and
about 10 to about 35 wt % of flat glass fiber.

Aspect 3. The article of Aspect 1 or Aspect 2, wherein the article is a screen component, a cover, an enclosure component for cell phones, computers, tablets, monitors, televisions, home appliances, automotive interior electronics, aircraft interior electronics, electrical & electronic devices, and home and construction parts.

Aspect 4. The article of any one of Aspects 1-3, wherein the composition includes two poly(aliphatic ester)-polycarbonate copolymers, a first poly(aliphatic ester)-polycarbonate copolymer having a weight average molecular weight of from about 15,000 to about 25,000, and a second poly(aliphatic ester)-polycarbonate copolymer having a weight average molecular weight of 30,000 to about 40,000.

Aspect 5. The article of any one of Aspects 1-4, wherein the first poly(aliphatic ester)-polycarbonate copolymer contains about 4.0 to about 7.0 mole % sebacic acid, and the second poly(aliphatic ester)-polycarbonate copolymer contains about 7.5 to about 9.0 mole % sebacic acid.

Aspect 6. The article of any one of Aspects 1-5, wherein at least one poly(aliphatic ester)-polycarbonate copolymer is derived from bisphenol-A and sebacic acid.

Aspect 7. The article of any one of Aspects 1-6, wherein the polymer having ester linkages comprises derived from cyclohexanedimethanol (CHDM).

Aspect 8. The article of Aspect 7, where in ester linkage comprises residues of one or mocyhclohexlendimethylene terephthalate glycol-modified (PCTG), polyethylene terephthalate glycol-modified (PETG), and polycyclohexylenedimethylene terephthalate (PCT).

Aspect 9. The article of Aspect 1, comprising poly(1,4-cyclohexane-dimethanol-1,4-cyclohexanedicarboxylate). poly(1,4-cyclohexane-dimethanol-1,4-cyclohexanedicarboxylate).

Aspect 10. The article of any one of Aspects 1-9 having a total transmittance of 85% as measured in accordance with ASTM D1003 at a thickness of 0.6 mm.

Aspect 11. The article of any one of Aspects 1-10, having a haze of less than 10% as measured in accordance with ASTM D1003 at a thickness of 0.6 mm.

Aspect 12. A method of forming an article comprising:
blending at least one poly(aliphatic ester)-polycarbonate copolymer, at least one polymer having ester linkages, and flat glass fiber to form a polymer mixture; and
molding the polymer mixture to form the article.

Aspect 13. The method of Aspect 12, wherein the molding process is a hot cool molding process. In some aspects, a hot cool molding process can further improve the light transmittance (transparency) and reduce haze.

Aspect 14. A method of forming an article comprising:
blending at least one poly(aliphatic ester)-polycarbonate copolymer, at least one polymer having ester linkages, and flat glass fiber to form a polymer mixture; and
molding the polymer mixture to form the article.

Aspect 15. The method of Aspect 14, wherein the article comprises:
about 40 to about 70 wt % of at least one poly(aliphatic ester)-polycarbonate copolymer;
about 20 to about 25 wt % of a polymer having ester linkages; and
about 10 to about 35 wt % of flat glass fiber.

Aspect 16. The method of Aspect 14 or Aspect 15, wherein the article is a screen or cover component for a cell phone, computer tablet, computer monitor or television.

Aspect 17. The method of any one of Aspects 13-16, wherein the article's composition includes two poly(aliphatic ester)-polycarbonate copolymers, a first poly(aliphatic ester)-polycarbonate copolymer having a weight average molecular weight of from about 15,000 to about 25,000, and a second poly(aliphatic ester)-polycarbonate copolymer having a weight average molecular weight of 30,000 to about 40,000.

Aspect 18. The method of any one of Aspects 14-18, wherein the first poly(aliphatic ester)-polycarbonate copolymer contains about 4.0 to about 7.0 mole % sebacic acid, and the second poly(aliphatic ester)-polycarbonate copolymer contains about 7.5 to about 9.0 mole % sebacic acid.

Aspect 19. The method of any one of Aspects 14-18, wherein at least one poly(aliphatic ester)-polycarbonate copolymer is derived from bisphenol-A and sebacic acid.

Aspect 20. The method of any one of Aspects 14-19, wherein the polymer having ester linkages comprises poly(1,4-cyclohexane-dimethanol-1,4-cyclohexanedicarboxylate).

Aspect 21. The method of any one of claims 14-20, wherein said article has a total transmittance of 85% as measured in accordance with ASTM D1003 at a thickness of 0.6 mm.

Aspect 22. The method of any one of Aspects 14-21, wherein said article has a haze of less than 10% as measured in accordance with ASTM D1003 at a thickness of 0.6 mm.

Aspect 23. A polymer composition comprising:
at least one poly(aliphatic ester)-polycarbonate copolymer;
at least one polymer having ester linkages; and
flat glass fiber.

Aspect 24. The polymer composition of Aspect 23 comprising:
about 40 to about 70 wt % of at least one poly(aliphatic ester)-polycarbonate copolymer;
about 20 to about 25 wt % of a polymer having ester linkages; and
about 10 to about 35 wt % of flat glass fiber.

Aspect 25. The article of any one of Aspects 23-24, wherein the composition includes two poly(aliphatic ester)-polycarbonate copolymers, a first poly(aliphatic ester)-polycarbonate copolymer having a weight average molecular weight of from about 15,000 to about 25,000, and a second poly(aliphatic ester)-polycarbonate copolymer having a weight average molecular weight of 30,000 to about 40,000.

Aspect 26. The article of any one of Aspects 23-25, wherein the first poly(aliphatic ester)-polycarbonate copolymer contains about 4.0 to about 7.0 mole % sebacic acid, and the second poly(aliphatic ester)-polycarbonate copolymer contains about 7.5 to about 9.0 mole % sebacic acid.

Aspect 27. The article of any one of Aspects 23-26, wherein at least one poly(aliphatic ester)-polycarbonate copolymer is derived from bisphenol-A and sebacic acid.

Aspect 28. The article of any one of Aspects 23-27, wherein the polymer having ester linkages comprises poly(1,4-cyclohexane-dimethanol-1,4-cyclohexanedicarboxylate).

### General Materials and Methods

The compositions as set forth in the Examples below were prepared from the components presented in Table 1.

TABLE 1
Components of the thermoplastic compositions.

| Item | Item Description |
|---|---|
| HFD Copolymer 1 | Sebacic Acid/BPA copolymer by SABIC contains 6 mole % |
| | sebacic acid, has a Mw = 21,500 by GPC. |
| HFD Copolymer 2 | Sebacic Acid/BPA copolymer by SABIC contains 8.5 mole |
| | % sebacic acid, has a Mw = 36,000 by GPC. |
| EXL PC | Transparent PC-Siloxane Copolymer by SABIC |
| PC 1 | BPA Polycarbonate by SABIC (22,000 Mw) |
| PC 2 | BPA Polycarbonate by SABIC (30,000 Mw) |
| PCCD | poly(1,4-cyclohexane-dimethanol-1,4-cyclohexanedicarboxylate) |
| BPADP | Bisphenol A bis(diphenyl phosphate), Flame retardant |
| Glass fiber 1 | GF ECS03T-120/PL, Nippon |
| Glass fiber 2 | Nittobo, CSG 3PA-830, flat fiber |
| Glass fiber 3 | Glass fiber, organic silane sized, having a diameter of about |
| | 13 micrometers and a pre-compounded length of about 4 |
| | millimeters (GF) |
| Siloxanes and Silicones | Siloxanes and Silicones, di-Me, di-Ph, polymers with Ph |
| | silsesquioxanes, methoxy-terminated” from MOMENTIVE; |
| | CAS number 68440-65-3. |
| ADR4368 | Stabilizer, Joncryl ™ ADR 4368CS |
| Stabilizer | P-EPQ, Phosphonous Acid Ester |
| MZP | Mono zinc phosphate |
| PETS | Pentaerythritol tetrastearate from FACT ASIA PACIFIC |
| | PTE LTD. |

Pencil hardness is determined by ASTM D3363. Total transmittance and haze are measured according to ASTM D1003. Mechanical and processing properties of interest include, but are not limited to, notched and unnotched Izod impact strength (tested in accordance with ASTM D256), heat deflection temperature (HDT, tested in accordance with ASTM D648), flexural modulus and flexural strength (tested in accordance with ASTM D790), tensile modulus/strength/elongation (tested in accordance with ASTM D638), and coefficient of thermal expansion (tested in accordance with ASTM E831).

Tables 2-4 list typical extrusion and compounding profiles of the compositions disclosed herein.

TABLE 2
Compounding Profile

| Parameter | UOM | Default |
|---|---|---|
| Zone 1 Temp | ° C. | 100 |
| Zone 2 Temp | ° C. | 180 |
| Zone 3 Temp | ° C. | 250 |
| Zone 4 Temp | ° C. | 260 |
| Zone 5 Temp | ° C. | 270 |
| Zone 6 Temp | ° C. | 270 |
| Zone 7 Temp | ° C. | 270 |
| Zone 8 Temp | ° C. | 270 |
| Zone 9 Temp | ° C. | 270 |
| Zone 10 Temp | ° C. | 270 |
| Zone 11 Temp | ° C. | 270 |
| Die Temp | ° C. | 270 |
| Screw Speed | rpm | 340 |
| Throughput | kg/hr | 60 |
| Melt | ° C. | 285 |
| Temperature | | |
| Torque | % | 85 |

TABLE 3
Typical Molding Profile for Color Chips

| Parameter | UOM | Default |
|---|---|---|
| Zone 1 Temp | ° C. | 270 |
| Zone 2 Temp | ° C. | 280 |
| Zone 3 Temp | ° C. | 285 |
| Zone 4 Temp | ° C. | 285 |
| Nozzle temp | ° C. | 280 |
| Hopper temp | ° C. | 50 |
| Mold temp | ° C. | 90 |
| Decompression | Mm | 3 |
| Injection Time | second | 0.350 |
| Holding Time | second | 15 |
| Cooling Time | second | 20 |
| Approx. cycle time | second | 40 |
| Shot volume | Mm | 45 |
| Max. Injection | bar | 800 |
| pressure | | |
| Cycle Time | second | 40 |
| Cushion | mm | 8.0 |
| Cnd: Pre-drying | hour | 4 |
| time | | |
| Cnd: Pre-dying | ° C. | 100 |
| temp | | |
| Screw Speed | rpm | 70 |
| Back Pressure | bar | 50 |
| Switch point(mm) | mm | 15 |
| Injection speed | mm/s | 100 |
| Holding Pressure | bar | 450 |

TABLE 4
H&C Injection Molding Parameter

| Parameter | Unit | Set Value |
|---|---|---|
| Drying temp | ° C. | 80 |
| Drying time | Hr | 4 |
| Processing Temp | ° C. | 280 |
| Tool Temp-High | ° C. | 125 |
| Tool Temp-Low | ° C. | 80 |
| Metering speed | m/s | 0.1 |
| Injection speed | mm/s | 200 |
| Max injection | Bar | 2100 |
| pressure | | |
| Holding pressure | Bar | 1500 |
| Holding time | sec | 3 |
| Cooling time | sec | 20 |
| Tool surface Ra | μm | 6 |

| | |
|---|---|
| Heating source | Induction(Roctool |
| | Technology) |
| Injection machine | Sumitomo |

** Screw diameter: 25 mm

Table 5 provides formulations used in the examples.

TABLE 5
Formulations

| Item | C1 | C2 | C3 | C4 | C5 | C6 | E1 | E2 |
|---|---|---|---|---|---|---|---|---|
| HFD | 17.6 | 25.71 | | | | | 14.53 | 22.96 |
| copolymer 1 | | | | | | | | |
| HFD | 40.54 | 25.02 | | | | | 39.28 | 24 |
| copolymer 2 | | | | | | | | |
| EXL PC | | | | 63.56 | 48.46 | 25.36 | | |
| PC 1 | | | 38.25 | 10 | 15.1 | 30 | | |
| PC 2 | | | 10 | | | | | |
| PCCD | 20.42 | 17.83 | 26 | 15 | 15 | 13 | 24.75 | 21.6 |
| BPADP | | | 10 | | | | | |
| Glass fiber 1 | 20 | 30 | | 10 | 20 | 30 | | |
| Glass fiber 2 | | | | | | | 20 | 30 |
| Glass fiber 3 | | | 15 | | | | | |
| Siloxanes and | 1 | 1 | | 1 | 1 | 1 | 1 | 1 |
| Silicones | | | | | | | | |
| ADR 4368 | | | 0.28 | | | | | |
| Stabilizer | 0.15 | 0.15 | 0.15 | 0.15 | 0.15 | 0.15 | 0.15 | 0.15 |
| MZP | 0.02 | 0.02 | 0.05 | 0.02 | 0.02 | 0.02 | 0.02 | 0.02 |
| PETS | 0.27 | 0.27 | 0.27 | 0.27 | 0.27 | 0.27 | 0.27 | 0.27 |

Table 6 presents results from the formulated compositions.

TABLE 6
Test Results

| Typical | Test | | | | | | | | | |
|---|---|---|---|---|---|---|---|---|---|---|
| Property | Method | Unit | C1 | C2 | C3 | C4 | C5 | C6 | E1 | E2 |
| T % (Lab), | ASTMD | % | 87.1 | 81.3 | | | | | 90.2 | 89 |
| 1 mm | 1003 | | | | | | | | | |
| T % (Lab), | ASTMD | % | 85.9 | 78 | 88.8 | 87 | 85 | 80 | 89.8 | 88.1 |
| 2 mm | 1003 | | | | | | | | | |
| T % (Lab), | ASTMD | % | 82.8 | 73.6 | | | | | 87.7 | 85.9 |
| 3 mm | 1003 | | | | | | | | | |
| Haze (Lab), | ASTMD | % | 36.6 | 71.1 | | | | | 10.2 | 14.5 |
| 1 mm | 1003 | | | | | | | | | |
| Haze (Lab), | ASTMD | % | 29.1 | 59.9 | 11.1 | 15 | 25 | 40 | 10.5 | 15.3 |
| 2 mm | 1003 | | | | | | | | | |
| Haze (Lab), | ASTMD | % | 44.4 | 68.8 | | | | | 17.8 | 20.2 |
| 3 mm | 1003 | | | | | | | | | |
| T % (no H&C), | ASTMD | % | | | | | | | 88.15 | 87.75 |
| 0.6 mm | 1003 | | | | | | | | | |
| T % (H&C), | ASTMD | % | | | | | | | 91.18 | 90.65 |
| 0.6 mm | 1003 | | | | | | | | | |
| T % (H&C), | ASTMD | % | | | | | | | 88.7 | 87.6 |
| 3 mm | 1003 | | | | | | | | | |
| Haze (no H&C), | ASTMD | % | | | | | | | 46.9 | 49.2 |
| 0.6 mm | 1003 | | | | | | | | | |
| Haze (H&C), | ASTMD | % | | | | | | | 4.88 | 8.22 |
| 0.6 mm | 1003 | | | | | | | | | |
| Haze (H&C), | ASTMD | % | | | | | | | 9.1 | 11.57 |
| 3 mm | 1003 | | | | | | | | | |
| TENS Stress, brk | ASTM | MPa | 58 | 51.5 | | | | | 98.6 | 119.6 |
| | D635 | | | | | | | | | |
| TENS Modulus | ASTM | MPa | 4837 | 6490 | | 3600 | 5800 | 8400 | 5800 | 8306 |
| | D635 | | | | | | | | | |
| FLEX Stress, brk | ASTM | MPa | 93.1 | 88.6 | | | | | 137 | 158 |
| | D970 | | | | | | | | | |
| FLEX Modulus | ASTM | MPa | 4120 | 5470 | 4730 | 3200 | 5000 | 7600 | 5290 | 7420 |
| | D970 | | | | | | | | | |
| IZOD, notched, | ASTM | J/m | 42.3 | 35.2 | 54.9 | | 150 | 130 | 111 | 132 |
| RT | D256 | | | | | | | | | |
| HDT | ASTM | ° C. | 102 | 102 | 79 | 116 | 118 | 118 | 100 | 100 |
| | D648 | | | | | | | | | |
| Pencil Hardness | 1000 g, | | | | | | | | HB | B |
| | 45 degree | | | | | | | | (H&C) | (H&C) |

The examples and figures illustrate that, among other things, the inventive formulations have a much higher percent transmittance (% T) and lower haze than their respective counterparts at the same glass fiber (GF) loading as well as superior optical performance. The examples of the instant disclosure should equal or better mechanical properties. Heat treatment and cool treatments, produce improvements in % T and haze with the instant formulations.

The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

1-20. (canceled)

21. An article comprising:
40 to 70 wt % of at least one poly(aliphatic ester)-polycarbonate copolymer;
20 to 25 wt % of a polymer having ester linkages; and
10 to 35 wt % of flat glass fiber.

22. The article of claim 21, wherein the article is a screen component, a cover, an enclosure component for cell phones, computers, tablets, monitors, televisions, home appliances, automotive interior electronics, aircraft interior electronics, electrical & electronic devices, and home and construction parts.

23. The article of claim 21, wherein the article comprises at least two poly(aliphatic ester)-polycarbonate copolymers, a first poly(aliphatic ester)-polycarbonate copolymer having a weight average molecular weight of from 15,000 to 25,000, and a second poly(aliphatic ester)-polycarbonate copolymer having a weight average molecular weight of 30,000 to 40,000.

24. The article of claim 21, wherein the article comprises at least a first poly(aliphatic ester)-polycarbonate copolymer comprising 4.0 to 7.0 mole % sebacic acid and a second poly(aliphatic ester)-polycarbonate copolymer comprising 7.5 to 9.0 mole % sebacic acid.

25. The article of claim 21, wherein the at least one poly(aliphatic ester)-polycarbonate copolymer is derived from bisphenol-A and sebacic acid.

26. The article of claim 21, wherein the polymer having ester linkages is derived from cyclohexanedimethanol (CHDM).

27. The article of claim 21, wherein the article has a total transmittance of at least 85% as measured in accordance with ASTM D1003 at a thickness of 0.6 mm.

28. The article of claim 21, wherein the article has a haze of less than 10% as measured in accordance with ASTM D1003 at a thickness of 0.6 mm.

29. A method of forming an article comprising:
blending 40 to 70 wt % of at least one poly(aliphatic ester)-polycarbonate copolymer, 20 to 25 wt % of at least one polymer having ester linkages, and 10 to 35 wt % of flat glass fiber to form a polymer mixture; and
molding the polymer mixture to form the article.

30. The method of claim 29, wherein the article is a screen component, a cover, an enclosure component for cell phones, computers, tablets, monitors, televisions, home appliances, automotive interior electronics, aircraft interior electronics, electrical & electronic devices, and home and construction parts.

31. The method of claim 29, wherein the article comprises at least two poly(aliphatic ester)-polycarbonate copolymers, a first poly(aliphatic ester)-polycarbonate copolymer having a weight average molecular weight of from 15,000 to 25,000, and a second poly(aliphatic ester)-polycarbonate copolymer having a weight average molecular weight of 30,000 to 40,000.

32. The method of claim 29, wherein the article comprises at least a first poly(aliphatic ester)-polycarbonate copolymer comprising 4.0 to 7.0 mole % sebacic acid and a second poly(aliphatic ester)-polycarbonate copolymer comprising 7.5 to 9.0 mole % sebacic acid.

33. The method of claim 29, wherein the at least one poly(aliphatic ester)-polycarbonate copolymer is derived from bisphenol-A and sebacic acid.

34. The method of claim 29, wherein the polymer having ester linkages is derived from cyclohexanedimethanol (CHDM).

35. The method of claim 29, wherein said article has a total transmittance of at least 85% as measured in accordance with ASTM D1003 at a thickness of 0.6 mm.

36. The method of claim 29, wherein said article has a haze of less than 10% as measured in accordance with ASTM D1003 at a thickness of 0.6 mm.

37. A polymer composition comprising:
40 to 70 wt % of at least one poly(aliphatic ester)-polycarbonate copolymer;
20 to 25 wt % of a polymer having ester linkages; and
10 to 35 wt % of flat glass fiber.
